(19) United States
(12) Patent Application Publication
(10) Pub. No.: US 2013/0219600 A1
(43) Pub. Date: Aug. 29, 2013

(54) Multi-layer non - woven fabric multi-use material for ballistic and stab resistance comprising impregnated and oriented fiber non - woven fabric layers; manufacturing, method, and protection garment produced thereby

(71) Applicants: Alberto Atorrasagasti, San Isidro (AR); Jorge Enrique Bosso, Mar Del Plata (AR)

(72) Inventors: Alberto Atorrasagasti, San Isidro (AR); Jorge Enrique Bosso, Mar Del Plata (AR)

(73) Assignee: MULTI AXIAL, LLC, Pembroke Pines, FL (US)

(21) Appl. No.: 13/403,907

(22) Filed: Feb. 23, 2012

(51) Int. Cl. F41H 1/02; B32B 5/26; B32B 5/28

(52) U.S. Cl. CPC F41H 1/02; B32B 5/28; B32B 5/26
USPC 2/463; 442/134; 2/455; 156/264

(57) ABSTRACT

Multi-layer non-woven fabric material composed of non-woven fiber sheets of aramide/polyethylene fibers, impregnated with resin and/or a filler material, and oriented at various angles, which is used for manufacturing protection garments. The invention also describes a method for manufacturing said multi-layer non-woven fabric material and the protection garments thus obtained.

### CROSS-REFERENCES

None

### GOVERNMENT RIGHTS

None

### OTHER PUBLICATIONS

None

### BACKGROUND OF INVENTION

1. Field of Invention

The present invention relates to a multi-layer anti-trauma material composed of non-woven fabrics made of impregnated fibers oriented at specific angles, impregnated with a resin and/or filler material. Said material is used in the manufacture of multi-threat body armors, for example vests and any other kind of garment, which are shrapnel-proof, stab-proof and against the penetration of piercing and cutting objects.

2. Description of the Related Art

In order to provide personal protection against projectiles or piercing objects, special fabrics or layers are used for the manufacture of body armors, vests, helmets, shields and any kind of safety and protection garment, for both industrial and sports purposes. Said layers and fabrics can be manufactured from fibers such as aramide, high molecular weight polyethylene and polybenzazoles. Said materials are disclosed in, for example, U.S. Pat. No. 7,073,538B2 to Bhatnagar published on Jul. 11, 2006, U.S. Pat. No. 7,288,307B2 to Bhatnagar published on Oct. 30, 2007, US 2001/0053645A1 to Henderson published on Dec. 20, 2001, US 2006/0121805A1 to Krulic published on Jun. 8, 2006, and in the International Patent Application PCT WO 2008/101138A1 to Bhatnagar, published on Aug. 21, 2008 as well as in Patent ES 2187013.

Said articles exhibit various degrees of resistance against the penetration of knives and in general of projectiles of any kind. High-strength fibers made of Ultra High Molecular Weight Polyethylene (UHMW PE), aramides and polybenzazoles are incorporated into these materials under various forms, either as hybrid compositions (mixtures of polyethylene and aramides, woven or non woven), rigid compositions (prepared by bonding of fabric layers under pressure) or flexible compositions. Fibers in a non-woven layer can be oriented in a single direction 0°/90°, typically containing a matrix resin to stabilize the structure.

Another known procedure comprises rotating the fabrics so that they will bear an angular relation of 0°/90° or 0°/45°/90°/45°/90° to each other, or in different angles, for the purpose of constructing rigid or moderately flexible materials, by bonding fabric layers under heat and pressure, so that the matrixes of individual layers become bonded into a single composite matrix of high mechanical strength, suitable for construction. The material thus obtained is characterized by such rigidity that, although it can be used with excellent results in armored structures, it is difficult to use in body armors, due to its limited flexibility.

The aforementioned references have several disadvantages. Those include inflexibility of the final product whether woven or non woven, increased weight of the product to adequately resist both projectile and piercing objects, inability to properly disperse impact energy so as to minimize trauma in its application to a vest type body armor. A need exists to provide low cost, low weight multi-threat body armor which is shrapnel-proof, stab-proof and can protect against the penetration of piercing and cutting objects. As such none of the above references discloses a material such as the one disclosed in the present invention. Therefore it is the object of this invention to solve one or more of these problems.

### SUMMARY OF INVENTION

In a first embodiment, the object of the invention comprises a non-woven/UD band comprised by a first set of unidirectional, continuous threads/filaments, laid down in a first plane of UHMWPE 1000 and a second set of unidirectional continuous threads/filaments on top of said first plane laid down transversely in different angles to the first set of threads. By applying different information techniques, the drawing ratio (% elongation at break), ASTM D-638 and DIN 53455 in a percentage value of UHMW/PE 1000 of 350, as well as the elasticity module (kg/cm2 tension) ASTM D-638 and DIN 53457 in a tension value of UHMW/PE 1000 of 6000 may be achieved.

In the case of aramid fibers made up from aromatic polyamides filed in U.S. Pat. No. 3,671,542, with different formulas, will give a tenacity of 23 g/denier, 203 cN/tex/424000 psi, 2920 Mpa, 1500 denier/1670 dtex.

For example, poly(p-phenylene terephthalamide), filament's produced by DuPont®, under the trademark KEVLAR® used in the formation of different composites resistant to ballistic impact and whose commercial denomination is KEVLAR® 29/129 are compatible for use in this invention. Also, the poly(m-phenylene isophthalamide) fibers (whose commercial denomination is NOMEX®) produced by DuPont® are also compatible for this invention.

In accordance with the teachings of this invention as embodied and described herein, an improved multi-layer non-woven fabric material composed of multiple non-woven fabric layers or laminates each made up of individually impregnated unidirectional fiber sheets and superimposed so that the fibers in each layer of non-woven fabric form various angles of 0° to 90°, including but not limited to 20°, 25°, 30°, 35°, 40°, 45°, 50°, 55°, 60°, 65°, 70°, 75°, 80°, and 90° and so on with the fibers of the adjacent layer or non-woven fabric. Each layer is impregnated with a resin and/or filler material. As many non-woven fabric layers as desired can be superimposed, depending on the intended purpose of the material. The superimposed non-woven fabric layers are not bonded or glued together only joined at the ends; therefore a flexible material is obtained, ideally suited for its use in garments. The protection garments manufactured with the multi-layer non-woven fabric material of the invention, in addition to having greater flexibility, achieve an optimum resistance to penetration by projectiles, and also, most remarkably, are more resistant to penetration by piercing objects than the state-of-the-art materials.

The present invention, which comprises non-woven fabric layers individually impregnated with a resin material. Each non-woven fabric layer is superimposed so that the fibers in each layer form angles of 0°/90°, 0°/20°, 0°/25°, 0°/30°, 0°/35°, 0°/40°, 0°/45°, 0°/50°, 0°/55°, 0°/60°, 0°/65°, 0°/70°, 0°/75°, 0°/80° with the fibers of the adjacent layer. As many non-woven fabric layers as desired can be superimposed, depending on the intended purpose of the material (i.e. fewer layers for flexibility and more layers for rigidity). The superimposed non-woven fabric layers are not bonded or glued together; therefore a flexible material is obtained, ideally suited for its use in garments. The protection garments manufactured with the multi-layer non-woven fabric material of the invention, in addition to having greater flexibility, achieve an optimum resistance to penetration by projectiles, and also, most remarkably, (due to the incorporation of the resin impregnation) are more resistant to penetration by piercing objects than the state-of-the-art materials.

It is evident that the multi-axial band of the invention may be composed of a larger quantity of intermediate planes and/or different rotation angles between the planes of yarns which are illustrated in the figures. For the purposes of this invention, the fiber is dimensionally elongated in its length, being larger than the width transversal dimensions. Consequently, the fiber term includes fiber filaments, regular or the irregular to the transversal section of different angles.

A thread is a continuous strand composed by many fibers or filaments. The fibers making up the thread may be continuous along the length of the thread or fibers. The threads of unidirectional continuous filaments are the main structural components of the unidirectional band in different multi-axial angles of the invention. The threads of unidirectional continuous filaments may be incorporated the material in different fibers independently formed in groups by: polyolefins of high molecular weight, aramids, polybenzazoles and/or a mixture thereof.

A first object of the present on s to provide a multi-layer non-woven fabric material composed of multiple flexible non-woven fabric layers or laminates made of oriented unidirectional fiber sheets wherein said non-woven fabric layers are superimposed so that the fiber in one non-woven fabric sheet form a certain angle with the fibers in adjacent non-woven fabric sheets.

A second the present invention is to provide a flexible multi-layer non-woven fabric material wherein the non-woven fabric layers made of oriented unidirectional fiber sheets are impregnated with a resin.

A third object of the present invention is to provide a flexible multi-layer non-woven fabric material wherein the non-woven fabric layers made of oriented unidirectional fiber sheets are impregnated with a resin as well as a filler material.

A fourth object of the present invention is the use of the multi-layer non-woven fabric material to make body armors or other protection and security garments and elements with substantially reduced weight over that currently available in the prior art.

A fifth object of the present invention is to provide a method for manufacturing the flexible material disclosed herein.

### BRIEF DESCRIPTION OF DRAWINGS

FIG. 1 is a top perspective view of the non-woven multi-layered non-woven fabric manufacture, at 0°/90°, and 30°/120°.

FIG. 2 is a top perspective view of the non-woven fabric layer or laminate manufacture, at 0°/20°, 0°/25°, 0°/30°, 0°/35°, 0°/40°, and 0°/45°.

FIG. 3 is a top perspective view of the non-woven fabric layer or laminate manufacture, at 0°/50°, 0°/55°, 0°/60°, 0°/65°, 0°/70°, and 0°/75°.

FIG. 4 is a top perspective view of the non-woven fabric layer or laminate manufacture, at 0°/80°.

### DETAILED DESCRIPTION OF THE INVENTION

It is defined here that fiber is to be understood to mean a longitudinally extended series of filaments, microfilaments, ribbons, threads, strips, films, or the like having a regular or irregular cross section with the length of said fiber being substantially longer than the width and thickness. It is also to be understood that a prepreg, fiber sheet, or unidirectional fiber sheet refers to that which is being constructed from a series of parallel fibers joined together through gluing and possibly to be pre-impregnated with a resin. The majority of the fibers comprising the matrix structure are to be parallel to each other. The matrix, matrix composite, laminate, or non-woven fabric layer structure disclosed is the joining of two or more different fiber sheets through varying angles. Finally a multi-layer non-woven fabric is to be understood to mean the non adhesive joining of the ends of two or more non-woven fabric layers through varying angles.

In one of its preferred embodiments, the material of the present invention is prepared with non-woven fabrics or aramide/polyethylene fiber sheets supplied in rolls called “prepreg”, which are slightly pre-impregnated with a resin, to consolidate the structure of the fiber non-woven fabric at 0°/90°, thus providing it sufficient consistency to be unrolled for handling purposes. Even though the objects of the invention could be achieved with any kind of fiber sheet, as long as said fiber sheet meets the above-mentioned specifications, the fiber sheet used for the invention may be, without limitation, any of the fiber sheets or composites marketed world-wide by the Honeywell company under the trade names GoldShield® GV 2112/GN 2115/GN 2117/GN 2118/GV 2018, Spectra Shield® SR 1214/SRII 3124 y SRII 3130.

To said non-woven prepreg fiber sheet, resins selected from products in thermally stable laminates, amines, cyanates, epoxis, phenolics, non-saturated polyesters, bismaleimides, polyurethanes, silicones, esters, vinyls and their copolymers and mixtures thereof are incorporated by impregnation under high pressure. Polyurethane resins are particularly preferred. Some trade names of preferred resins are, for example, Baycoll® AS 2060, Desmudur® L 75, Desmophen® 1150 and Desmodur® N75 MPA/BA resins from the Bayer Company, and preferentially the Resinex® 4 resin.

As mentioned above, such chemical compounds (resins) are in general terms applicable to non-woven fabrics. However, different resins provide different advantages and results according to specific goals. Resinex® 4 resin performs best for the purposes of the present invention. The impregnation is carried out in a continuous process, under pressures in the range of 100 psi to 1900 psi (6.89 to 131 bars) and at temperatures between 120 and 145° C. (248 and 293° F.). The roll of non-woven fabric is impregnated and later air-dried at elevated temperature.

The features of Resinex® 4 resin are set forth below

| Properties | Resin | | Hardener | |
|---|---|---|---|---|
| Appearance | Black liquid | | Brown liquid | |
| Viscosity (at 20° C.) | 3500-5500 | mPas | 100-250 | mPas |
| Specific Gravity (at 20° C.) | 1.31 | | 1.24 | |
| Flash Point | >200° | C. | >200° | C. |

| Properties of the mixture | Test parameters |
|---|---|
| Mixture Ratio (by weight) | 100 resin/25 hardener |
| Gel Time (at 20° C.) | 30-50 minutes |
| Curing Time (at 20° C.) | 24 hours |

| Properties of the cured mixture | Test parameters | |
|---|---|---|
| Specific Gravity | 1.29 | |
| Hardness (Shore A) | 92 | |
| Tensile Strength | 570 | psi |
| Volume shrinkage after curing | 2% | |
| Electric Resistance | 11 | kV/mm |
| Thermal Conductivity 20-100° C. | 0.4-0.5 | W/mK |

| | |
|---|---|
| Water Absorption | 0.15-0.2% |

Impregnation of the prepreg with resins causes the microfilaments of threads or aramidic/polyolefin fibers to stick together even more, thus giving the non-woven fabric sheet and thus the non-woven fabric a better structure and obtaining a better control of the displacement of each microfilament in the laminar assembly of the non-woven fabric's general structure. The resin incorporated into the fiber sheet by impregnation will bond neighboring filaments all over the fiber sheet area, thus preventing them from displacing when the non-woven fabric is penetrated by a piercing or cutting object. In non-woven fabrics of the prior art, the microfilaments of the fibers would displace or be pushed apart, thus allowing any piercing object such as for example a hypodermic syringe to penetrate.

By forming such kind of structure, comprising thread microfibers and impregnating resins binding them, the threads are locked in position and their displacement with respect to their normal orientation angle 0°/90° in non-woven fabrics is reduced by 50% when a projectile or cutting/piercing object penetrates the non-woven fabric, by considerably dissipating its kinetic energy. A completely different result is obtained than with a non-impregnated non-woven fabric.

None of the fabrics of the prior art contains resins as those specified hereinbefore, which differ from those used in pre-impregnation or “prepreg”, so to give the non-woven fabric a structure with a high anti-trauma performance compliant with IIA-II-IIIA levels of NIJ 0101.06 Standard for body armors, and a performance against the penetration of piercing-cutting objects exceeding levels 1, 2 and 3/Spike/P1 and S1 of the NH 0115.00 Standard.

In a second embodiment, in addition to impregnating the non-woven fabric sheets with resins as described above, a filler material can be added thereto. The purpose of this procedure is to obtain a better structured material, resistant to piercing objects. The addition is carried out by adding a particulate material selected, without limitation, from the group comprising aluminum oxide, titanium oxide, carbon/boron oxide, silicon oxide, silicon dioxide, quartz oxide, silicon carbide, titanium carbide, hard glass, etc. In a preferred embodiment, the particulate material used is SiO₂. The addition of said particulate material or filler material can be carried out together with the impregnation with resin and before cutting the layers for the manufacture of for example, the body armors, or else can be added after cutting the layers for their intended purpose. The pre-impregnated non-woven fabric used as starting material has a total area density of approximately 107±15 g/m².

If the purpose is to manufacture bullet-proof garments, the starting pre-impregnated fiber sheet will preferably be impregnated only with resins. Impregnation can be carried out on one or both sides of the fiber sheet, depending on the intended result. If resin is applied on only one side of the fiber sheet, the resulting total area density of the non-woven fabric will be of about 125±15 g/m², that is, will increase by about 17% with respect to the initial total area density. If impregnation is made on both sides of the non-woven fabric, the total area density achieved will be of about 138±15 g/m².

If the purpose is to obtain a piercing-proof garment, it is then necessary to impregnate the fiber sheet with resins as well as the filler material. If the resin and the filler material are added on only one side of the non-woven fabric, the total area density will become of 170 g/m², while if resin and filler are applied to both sides of the non-woven fabric, the total area density will become of 234 g/m².

While the quantity of resin applied is the same in the different processes, the quantity of filler material added will determine the number of non-woven fabric layers necessary to form the multi-layer non-woven fabric material; the higher the quantity of filler material added, the lesser will be the number of non-woven fabric layers needed.

To obtain the multi-layer non-woven fabric material of the present invention, besides adding the resins and/or fillers to the non-woven fabrics, the non-woven fabric layers must be oriented in a specific way to obtain a performance against the penetration of bullets, cutting objects and piercing objects in compliance with standards 0101.06 and 0115.00 of the US National Institute of Justice, all in the same product.

Unexpected results have been obtained using non-woven fabrics made of aramide/polyethylene, impregnated with resins and superimposed so that the angle formed by the fibers in two adjacent non-woven fabric layers (or laminate) is different from zero degrees. Such an intercrossing of fiber orientation of adjacent non-woven fabric layers significantly reduces the size of the openings or gaps among the fibers. A smaller opening between fibers is one of the reasons behind the increased resistance of the disclosed material to piercing objects. Undoubtedly, the higher the number of non-woven fabric layers with fibers sheets at different angles, the smaller will be the openings between fibers; hence the penetration by a piercing object will be less probable.

According to the above description, resins were used to impregnate non-woven material made of aramide/polyethylene fiber sheets. The impregnation was carried out after properly placing each of the non-woven fabric sheets, one on top of the other. The incorporation of resins in the impregnation process, allowed decreasing the number of non-woven fabric layers for their testing against a cutting object. The use of a material formed by non-woven fabric layers impregnated with resin and superimposed so that their fibers form a certain angle therebetween, allows an improvement of about 30 to 50% in comparison with a material formed by intercrossed non-impregnated non-woven fabric layers.

The assembly of flexible layers of the invention will not be attached to each other, that is, there will be no adhesive between them, thus forming a material made of multiple non-woven fabrics or multiple layers stacked or superimposed, that will become a part of a protective garment or piece of clothing. The only attachment between such pieces of non-woven fabric will be along the edges of the garment, so as to allow the non-woven fabric to adopt the intended shape of the garment. Said garment or piece of clothing made with the material of the invention, depending on the number of superimposed non-woven fabric layers and the use of resins, will withstand the penetration of cutting/piercing objects in compliance with levels 1, 2 and 3 Spike, P1 and S1 of the NH 0115.00 Standard and/or to the penetration of bullets in compliance with protection levels IIA, II and IIIA of NH 0.101.06 Standard.

### EXAMPLES

1) Impregnation with Resins

A roll of non-woven fiber sheet made of aramide/polyethylene fibers (GoldShield GN 2115®/2117-2118/Spectra Shield SR 1224-Spectra Shield II 3124-3130 of Honeywell) with a total area density of 107 g/m² is spread and impregnated on one of its sides with 18-25 g/m² of a polyurethane resin (Rhesinex 4) under a pressure of approximately 146 psi (10 bars) and a temperature of about 130° C. (266° F.). After impregnation with resin, a fiber sheet with a total area density of about 125 g/m² is obtained. The same process is carried out, now impregnating both sides of the fiber sheet instead of just one, thus obtaining a fiber sheet with a total area density of about 138 g/m².

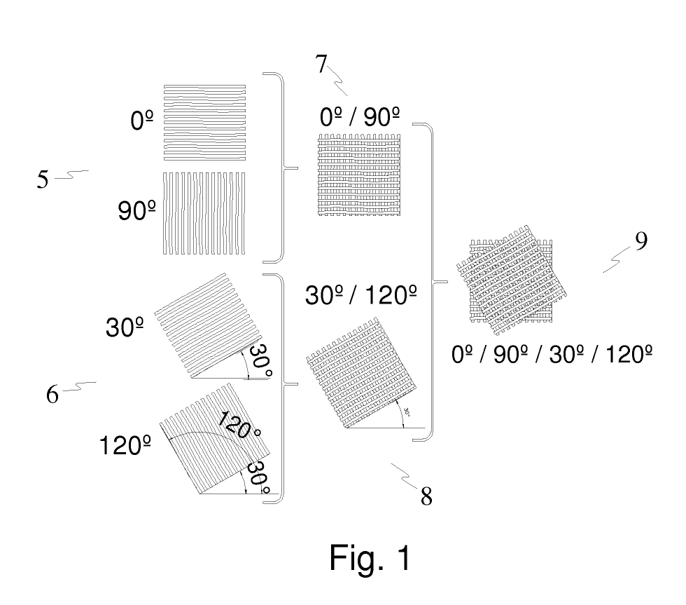

Referring now to the drawings, and more particularly FIG. 1, the present invention includes a non-woven multi-layer non-woven fabric structure 9 comprising two sets of fiber sheets or prepreg 5 of 110 grs/m² joined through gluing at angles of 0°/90° respectively and another two sets of fiber sheets 6 of 110 grs/m² joined through gluing at angles of 30°/120° respectively. This process creates two composite sheets 7 of 0°/90°, and 8 30°/120° which are overlaid as composite sheet 8 is further joined to laminates or non-woven fabric layers 7 through an angle of 30° forming a final laminate 9 forming angles of 0°/90°/30°/120°.

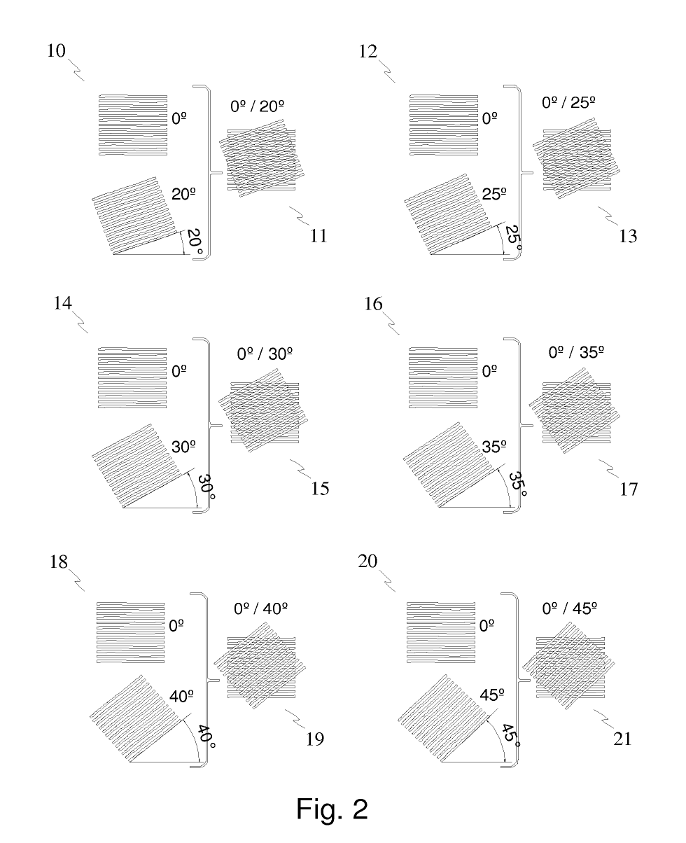

This process is repeated with the same fiber sheets of 110 grs/m² through various angles as shown and discussed in FIGS. 2-4. FIG. 2 shows two sets of fiber sheets 10 joined at angles of 0°/20° respectively forming a fiber layer 11 with angles of 0°/20°. This process is continued with fiber sheets 12, 14, 16, 18, and 20, forming fiber layers 13, 15, 17, 19, and 21, at angles of 0° and 25°, 30°, 35°, 40°, and 45° respectively.

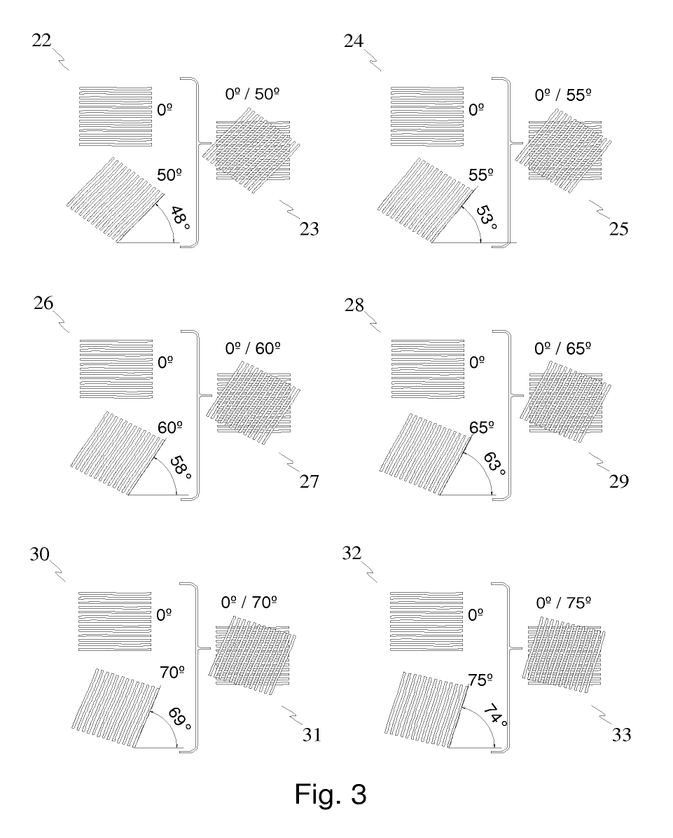

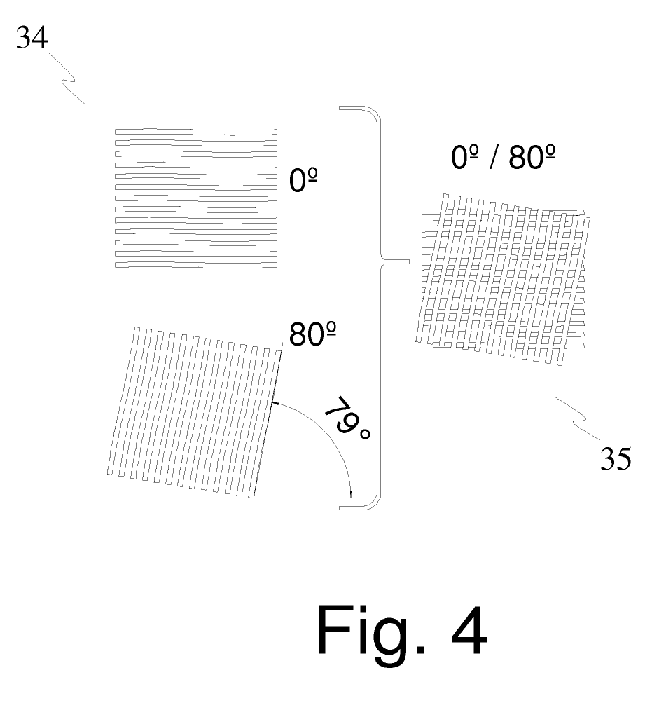

FIG. 3 shows the continued overlaying of fiber sheets 22, 24, 26, 28, 30, and 32, forming fiber layers 23, 25, 27, 29, 31, and 33, at angles of 0° and 50°, 55°, 60°, 65°, 75° and 45° respectively. And finally FIG. 4 shows the last fiber layer 35 from the overlaying and joining of sheets 34 at an angle of 0° and 80°.

### Comparative Tests

A) Ballistic test
B) Piercing and stabbing test
A) Ballistic results: This test was performed on two different materials. The first material was made by superimposing 30 non-woven fabric layers as manufactured (non traced fabrics). A second multi-layer material was made according to the present invention, and consisted of 30 non-woven fabric layers superimposed with the crossing angles mentioned above (traced fabrics).

Comparing the ballistic test results of traced fabrics (defined as those with fibers oriented at different angles) with those of non-traced fabrics (defined as those with fibers oriented at angles of 0/90°) it can be observed that the projectiles, upon penetrating the multi-layer non-woven fabric material of the present invention, exhibit a greater degree of deformation, which means that the material made with traced fabrics of the present invention dissipates energy more efficiently than the material made with non traced fabrics. Such an improvement bears a direct relationship with the ballistic performance regarding penetration of a projectile, since it is observed that the projectile penetrates a lower number of layers, thus providing greater protection and safety to the user. The traumatic effect was reduced by 25% as compared to the results obtained with the original material, with fabrics intercrossed at angles of 0°/90°.
1) By incorporating resin on one side of the non-woven fabric, even better results are obtained regarding the deformation of incoming projectiles, number of layers penetrated, energy dissipation and displacement of threads in the area affected by the projectile. The use of these non-woven fabrics leads to a reduction of 36% in the traumatic effect as compared to standard fabrics with no intercrossing or impregnation.
2) By incorporating resin to both sides of the non-woven fabric used for the material of the invention, the results are even better, in terms of greater protection obtained from the non-woven fabrics, greater dissipation of kinetic energy and lower traumatic effect, thus providing greater protection as compared to the material made with fabrics which have been resin-impregnated on only one side, and leading to a traumatic reduction of 50%.
   B) Results of Piercing and stabbing Tests
1) The original non-woven fabric as manufactured (0°/90°) is taken as a reference. Using same number of non-woven fabric layers the axial system with tracing was incorporated to the original non-woven fabric 0°/90° as produced by the manufacturer,
2) As mentioned above, Goldshield 2112/2115/2116/2117/2118/Spectra Shield SR 1224-Spectra Shield II 3124-3130, materials are compatible with our disclosure. But only when incorporating the tracing system we were able to obtain advantageous results regarding the performance against piercing and cutting objects as compared to the non-woven fabrics used in their original condition 0°/90°.
3) These parameters were tested and confirmed at three National Institute of Justice (NU) accredited HP White laboratories in the US under the NU-0.115.00 standard.
4) After confirming the validity of these results in this prestigious laboratory, we continued the development of the materials of the invention by incorporating the use of resins.
5) The incorporation of resins resulted in the obtaining of better results, in comparison to those described above. The resistance to penetration of piercing and cutting objects was improved, and the number of necessary non-woven fabric layers was significantly reduced.
6) By adding a filler material to the resin, even better results were obtained, since the number of non-woven fabric layers to achieve the same performance can be reduced even further. Therefore, by applying the three systems together: intercrossing of fibers, plus the use of resin, plus the incorporation of a filler material, the total number of non-woven fabric layers can be reduced by about 50%.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

1. A multi-layer material composed of impregnated and axially-oriented fiber fabrics comprising at least two non-woven fabric layers made of axially-oriented fibers and placed one on top of the other wherein the fibers in one of the fabric layers forming an angle different from zero degrees with respect to the fibers in the adjacent fabric layer.

2. The multilayer material of claim 1, wherein said fabric layers have been impregnated with resin.

3. The multilayer material of claim 2, wherein said fabric layers have been further impregnated with a filler material.

4. The multilayer material of claim 1, wherein the fibers of said non-woven fabric layers are aramide fibers.

5. The multilayer material of claim 1, wherein the resin is a polyurethane resin.

6. The multilayer material of claim 1, wherein the angle between the fibers in one fabric layer and the fibers in the nearest adjacent fabric layer is of 45°.

7. The multilayer material of claim 3, wherein the filler material used is SiO₂.

8. A method to obtain the multi-layer material according to any of the preceding claims comprising:
impregnating a non-woven fabric comprising aramide fibers with a resin;
adding a filler material into said resin-impregnated fabric;
cutting the fabric into multiple fabric pieces according to a given cutting pattern; and
superimposing multiple fabric layers to form the multi-layer material,
wherein said fibers of the fabric form angles of 0°/90°, 0°/20°, 0°/25°, 0°/30°, 0°/35°, 0°/40°, 0°/45°, 0°/50°, 0°/55°, 0°/60°, 0°/65°, 0°/70°, 0°/75°, 0°/80° with respect to the longitudinal axis of the cutting pattern; and
wherein said fibers in one fabric layer form an angle of 45° with the fibers in the adjacent fabric layer.

9. The multilayer material of claim 1, wherein said material forms a protection garment.

10. The multilayer material of claim 9, wherein said protection garment is a bullet-proof vest.

11. The multilayer material of claim 3, wherein said material forms a protection garment.

12. The multilayer material of claim 11, wherein said protection garment is a multi-threat body armor.

13. The multilayer material of claim 9 or 12, wherein said impregnated and axially-oriented fiber fabric layers of said multi-layer material are only attached along the edges of the garment.
